(19) United States
(12) Patent Application Publication
(10) Pub. No.: US 2018/0032970 A1
(43) Pub. Date: Feb. 1, 2018

(54) PROXIMITY PATIENT DETAILS SYSTEM

(71) Applicant: Aetna Inc., Hartford, CT (US)

(72) Inventors: Mark SCHEEL, Denver, CO (US); Matthew HARRIS, Englewood, CO (US); John RUNDLE, Sammamish, WA (US); Tim MORGAN, Wilmington, NC (US)

(73) Assignee: Aetna Inc., Hartford, CT (US)

(21) Appl. No.: 15/660,378

(22) Filed: Jul. 26, 2017

Related U.S. Application Data
(60) Provisional application No. 62/366,816, filed on Jul. 26, 2016.

(51) Int. Cl. G06Q 10/10; G06F 19/00; G06Q 50/22; H04W 4/02; G06F 17/24

(52) U.S. Cl. CPC G06Q 10/1095; H04W 4/023; G06F 17/243; G06Q 50/22; G06F 19/322

(57) ABSTRACT

Embodiments of the disclosure provide a method of filling out one or more forms by a mobile device. The mobile device detects signals from a beacon and determines proximity to the beacon. The mobile device then receives the forms from a remote server when the mobile device determines it is within a certain distance from the beacon. The mobile device then populates information in the forms and sends the forms to the remote server.

### CROSS-REFERENCE TO RELATED APPLICATIONS

This patent application claims the benefit of U.S. Provisional Application No. 62/366,816, filed Jul. 26, 2016, which is incorporated by reference.

### BACKGROUND

While visiting a doctor's office, filling out paper forms repeatedly with the same information is undesirable for many consumers. Additionally, after filling out the paper form, an individual employed by the office may need to transfer the information to an electronic record. In the process, this individual may make mistakes. For instance, sometimes the individual cannot read a consumer's handwriting and makes an educated guess. In other instances, a typing error may occur. Accumulation of errors may prove financially costly to correct by a consumer, doctor's office or insurance provider.

### SUMMARY

Embodiments of the disclosure provide a method of filling out one or more forms by a mobile device. The mobile device detects signals from a beacon and determines proximity to the beacon. The mobile device then receives the forms from a remote server when the mobile device exceeds a proximity threshold. The mobile device then populates information in the forms and sends the forms to the remote server.

Embodiments of the disclosure provide a method of securely filling out one or more forms by a mobile device with a wireless network interface. The method includes: detecting a signal from a beacon using the wireless network interface; determining a distance from the mobile device to the beacon using the detected signal from the beacon; receiving the one or more forms from a remote server when the distance from the mobile device to the beacon is within a predetermined distance from the beacon; populating fields in the one or more forms with the aid of a user information database, wherein the user information database stores centralized data used to fill the missing fields in the forms; and sending the forms to the remote server.

Further embodiments of the disclosure provide a mobile device for securely filling out one or more forms. The mobile device includes: a wireless network interface; and a processor configured for: detecting a signal from a beacon using the wireless network interface; determining a distance from the mobile device to the beacon using the detected signal from the beacon; receiving the one or more forms from a remote server when the distance from the mobile device to the beacon is within a predetermined distance from the beacon; populating fields in the one or more forms with the aid of a user information database, wherein the user information database stores centralized data used to fill the missing fields in the forms; and sending the forms to the remote server.

Yet further embodiments of the disclosure provide a non-transitory computer readable storage device for securely filling out one or more forms by a mobile device with a wireless network interface. The non-transitory computer readable storage device having computer executable instructions for performing the steps of: detecting a signal from a beacon using the wireless network interface; determining a distance from the mobile device to the beacon using the detected signal from the beacon; receiving the one or more forms from a remote server when the distance from the mobile device to the beacon is within a predetermined distance from the beacon; populating fields in the one or more forms with the aid of a user information database, wherein the user information database stores centralized data used to fill the missing fields in the forms; and sending the forms to the remote server.

### BRIEF DESCRIPTION OF THE DRAWINGS

FIG. 1 is a block diagram illustrating a networking environment in accordance with some example embodiments of the disclosure;

FIG. 2 is a flow diagram illustrating steps involved when a client device is proximate to a beacon according to some embodiments of the disclosure; and

FIG. 3 provides an electronic device according to an embodiment of the disclosure.

### DETAILED DESCRIPTION

While visiting a doctor's office, filling out paper forms repeatedly with the same information is undesirable for many consumers. Additionally, after filling out the paper form, an individual employed by the office may need to transfer the information to an electronic record. In the process, this individual may make mistakes. For instance, sometimes the individual cannot read a consumer's handwriting and makes an educated guess. In other instances, a typing error may occur. Accumulation of errors may prove financially costly to correct by a consumer, doctor's office and/or insurance provider. Using certain embodiments of the disclosure to integrate scheduling with proximity detection may reduce errors in records and also save a consumer's time.

Embodiments of the disclosure use beacon technology to determine when a patient enters an office for a scheduled appointment. The patient is prompted to verify their patient details on a smart device. The smart device may then pass the confirmed details digitally to an office administrator obviating the need for paper forms. Medical offices that take appointments benefit from this because consumer satisfaction is increasingly driving patient rating systems to influence medical decisions. By improving consumer satisfaction, embodiments of the disclosure provide a strategic competitive advantage to medical offices.

Embodiments of the disclosure provide a system with low cost beacons in a doctor's office that helps a phone application on a patient's mobile device realize when the patient is proximate the doctor's office, for example, in the waiting room. The application on the patient's mobile device will then prompt the patient to confirm the visit to the doctor. The application will then rely on previously entered data to fill out one or more forms that the doctor's office would need for the visit. The information may include patient's name, address, phone number, social security number (SSN), insurance information, etc. The application will then upload the completed forms to the doctor's file system.

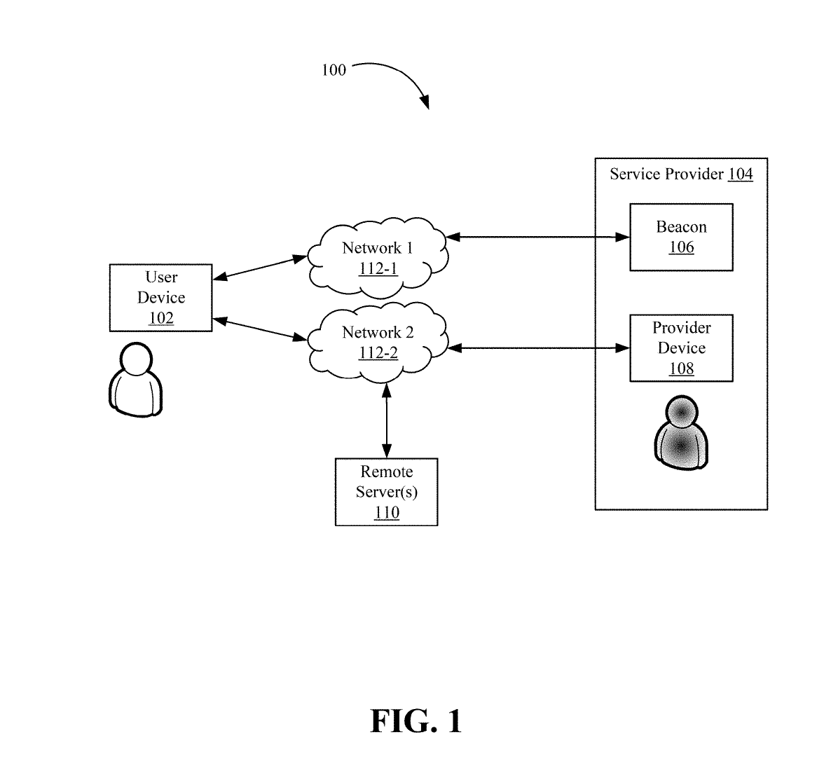

FIG. 1 illustrates a networking environment 100 according to some embodiments of the disclosure. When a user is in close proximity to a beacon 106 at a service provider 104, the user device 102 (the user's mobile device) detects proximity of the beacon through network 112-1. In networking environment 100, user device 102 may be communicably coupled to remote server(s) 110 through a network 112-2, and remote server(s) 110 may be communicably coupled to provider device 108.

User device 102 may be a mobile phone, a smartphone, a personal digital assistant, etc. User device 102 may include a processor, a display, and user interface devices such as input interface devices like buttons, touchscreens, and cameras. User device 102 may further include one or more network interface devices to support one or more networks, for example, Bluetooth®, Wi-Fi, infrared, etc. In certain embodiments, network 112-1 may be a Bluetooth® network, a Wi-Fi network or a line of sight network like infrared communications. In certain embodiments, network 112-2 may be a Wi-Fi network or a mobile data network such as GSM (Global System for Mobile Communications), CDMA (Code division multiple access), or LTE (Long Term Evolution). In certain embodiments, network 112-2 may be a combination of these networks, for example, a combination of Wi-Fi, mobile data network, and wired networks.

Service provider 104 is a physical location, for example, an office space, building, hospital, clinic, bank, etc. Beacon 106 may be a low power networking device to mark a physical location of service provider 104. Beacon 106 may also be a wireless access point with a specific identification or Bluetooth® low energy (BLE) beacon. BLE beacons may be advantageous since they are inexpensive and can run for a long time on a low capacity battery. The service provider 104 also has one or more devices designated as provider device 108 in FIG. 1. In certain embodiments, the provider device 108 may encompass one or more of an office computer(s), a tablet device, a mobile device, a local server, and an office network connecting a plurality of computers, tablets, mobile devices, etc. A worker in the service provider 104 may use provider device 108 to perform essential activities of the service provider 104.

Remote server(s) 110 are one or more servers that provide support to service provider 104 and a user. Some remote server(s) 110 may be located at service provider 104. In a healthcare environment, some remote server(s) 110 may be a health insurance provider's servers containing patient information. In other embodiments, remote server 110 may be a cloud server.

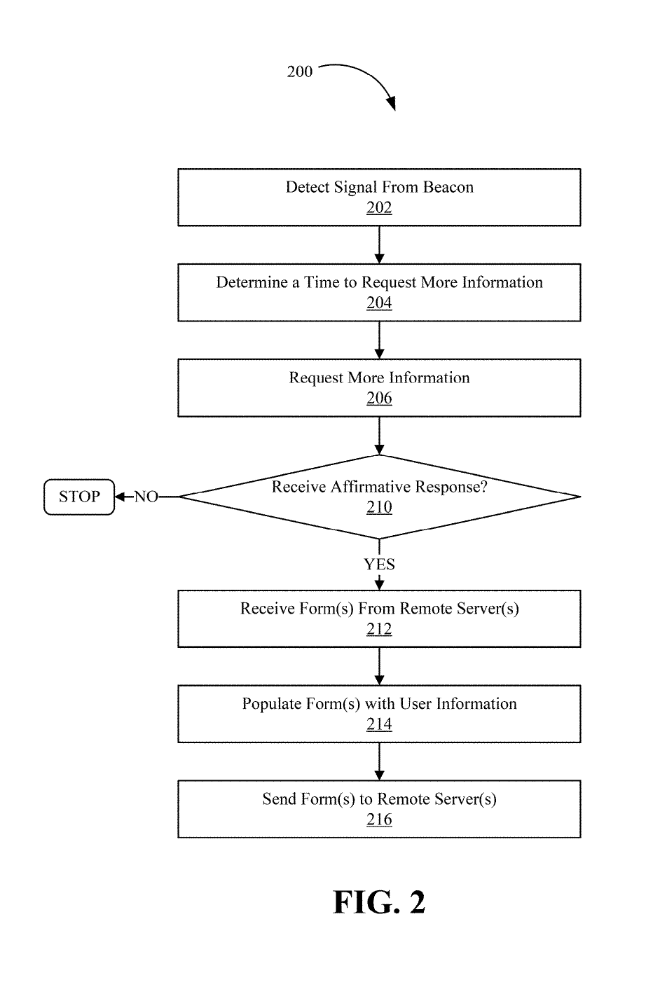

FIG. 2 is a flow diagram illustrating steps involved when a client device 102 is proximate to beacon 106 according to some embodiments of the disclosure. The process 200 in FIG. 2 will be explained in the context of a heathcare environment where a patient with a user device 102 enters a clinic (service provider 104). This is not meant to be limiting, but rather illustrative of steps performed in the disclosure in reference to any office environment where a consumer must provide certain routine paperwork. At step 202, the user device 102 detects a signal from beacon 106 through network 112-1.

At step 204, the user device 102 determines a time to request more information from the patient. This determination may be based on the power signal from the beacon, so depending on the signal strength between the user device 102 and beacon 106. When the signal strength exceeds a certain threshold, then the user device 102 requests more information from the patient. In another embodiment, the user device 102 may also determine the time based on the patient's appointment information in a digital calendar stored on the user device 102 or at remote server(s) 110. For example, at this step 204, the user device 102 may translate the signal strength to a distance from the beacon 106 and determine that more information needs to be collected once the signal strength indicates the user device 102 is within three meters of the beacon 106. In another embodiment, the user device 102 may further utilize both a digital calendar indicating a patient appointment along with the signal strength indicating proximity to the office so to raise a confidence factor that the user is attending the patient appointment. In a further embodiment, upon detection of the beacon the user device 102 could display a prompt to the user to validate that information should be provided to the clinic.

At step 206, the user device 102 requests more information from the patient. For example, the user device 102 provides a prompt or message to the patient asking whether to pull up and fill out medical forms for the clinic.

At step 210, the user device 102 receives a response from the patient. If the response is “NO,” then the process 200 stops. If the response from the patient is “YES,” then at step 212, the user device 102 receives one or more forms from remote server(s) 110. At step 214, the user device 102 fills out the forms with the patient's information. The patient's information may be retrieved from remote server(s) 110 through network 112-2 by the user device 102. In other instances, the user device 102 may have patient's information already stored on the device, so user device 102 fills out the forms from the patient's information already stored on the device.

In some embodiments, if there are fields where the user device 102 does not have information, the patient is prompted to provide a response. In some instances, the patient is asked to verify that information filled in the form is accurate, and if the patient finds an error, the patient may correct the error. After correcting the error, the user device 102 will take into account the correction and store the new information for next time the patient fills out a form.

At step 216, the user device 102 sends the forms to remote server(s) 110, and remote server(s) 110 will relay the forms to provider device 108. In the healthcare example, the user device 102 uploads the forms through network 112-2 to a health insurance company's server. The user device 102 may also provide an indication to the health insurance company's servers whether the uploading of the forms to the clinic's file system is successful. If the upload is not successful, then the user device 102 will continue to attempt to upload the forms until the upload is successful or the system times out or the upload is manually terminated. If the upload is successful, the health insurance company's server will upload the forms to the clinic's file system.

Embodiments of the disclosure provide security of patient data using information technology (IT). Since the beacon is positioned at a specific location, for example, at a clinic, location services are coupled with the transmission of sensitive information. Without sensing the beacon, the form that the patient fills out and sends to the healthcare provider is not accessible. As such, there are limited or designated zones or areas where a patient's mobile device shares sensitive patient data. Outside these zones or outside a certain distance from the beacon, the mobile device will be unable to receive the form and as such will not load sensitive patient information. Some embodiments of the disclosure may further enhance security by storing a configuration on the mobile device where the mobile device instructs a server storing patient information to provide the patient information for filling out a form. For example, when the patient's mobile device is proximate to a beacon, the mobile device sends a signal to the server with the patient information, and the server provides the patient's information to the healthcare provider.

Some embodiments of the disclosure may further enhance security and conserve the use of computing resources by having the patient's mobile device as a trigger to update the patient's information at a healthcare provider's file system. When the mobile device is in proximity to a beacon, the mobile device sends a signal to a server with the patient's information. The signal contains the mobile device's signature as well as the beacon's signature so that the server with the patient's information is able to use the beacon's information to locate the healthcare provider's server and the mobile device's signature to locate the patient's information. The server then provides patient information to the healthcare provider's server after determining which information is required by the healthcare provider's server. Security is enhanced because the mobile device being close to a beacon triggers exchange of information between two servers without the need of having sensitive patient information transferred to/from the patient's mobile device.

IT resources are utilized more efficiently because a centralized patient information database is configured to communicate with other databases to populate missing information or correct inaccurate information. With this configuration, the two databases communicate with one another, reducing the need to receive data traffic from the mobile device. The parameters or fields between the databases may then be standardized, allowing for efficient information flow without the need for excess conversions and translations of information and data formats.

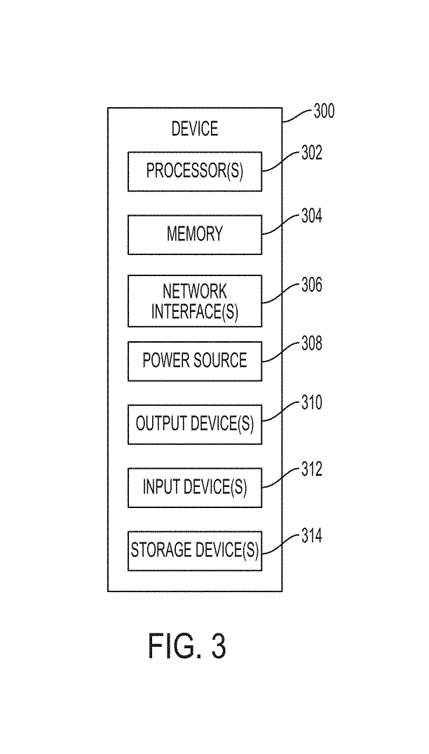

FIG. 3 illustrates an electronic device 300 according to an embodiment of the disclosure. Electronic devices, for example, servers and user devices comprising the user device 102, the remote server 110, the beacon 106 and the provider device 108, in certain embodiments, may be computer devices as shown in FIG. 3. The device 300 may include one or more processors 302, memory 304, network interfaces 306, power source 308, output devices 310, input devices 312, and storage devices 314. Although not explicitly shown in FIG. 3, each component provided is interconnected physically, communicatively, and/or operatively for inter-component communications in order to realize functionality ascribed to the various entities identified in FIG. 1 and referenced in FIG. 2. To simplify the discussion, the singular form will be used for all components identified in FIG. 3 when appropriate, but the use of the singular does not limit the discussion to only one of each component. For example, multiple processors may implement functionality attributed to processor 302.

Processor 302 is configured to implement functions and/or process instructions for execution within device 300. For example, processor 302 executes instructions stored in memory 304 or instructions stored on a storage device 314. In certain embodiments, instructions stored on storage device 314 are transferred to memory 304 for execution at processor 302. Memory 304, which may be a non-transient, computer-readable storage medium, is configured to store information within device 300 during operation. In some embodiments, memory 304 includes a temporary memory that does not retain information stored when the device 300 is turned off. Examples of such temporary memory include volatile memories such as random access memories (RAM), dynamic random access memories (DRAM), and static random access memories (SRAM). Memory 304 also maintains program instructions for execution by the processor 302 and serves as a conduit for other storage devices (internal or external) coupled to device 300 to gain access to processor 302.

Storage device 314 includes one or more non-transient computer-readable storage media. Storage device 314 is provided to store larger amounts of information than memory 304, and in some instances, configured for long-term storage of information. In some embodiments, the storage device 314 includes non-volatile storage elements. Non-limiting examples of non-volatile storage elements include floppy discs, flash memories, magnetic hard discs, optical discs, solid state drives, or forms of electrically programmable memories (EPROM) or electrically erasable and programmable (EEPROM) memories.

Network interfaces 306 are used to communicate with external devices and/or servers. The device 300 may comprise multiple network interfaces 306 to facilitate communication via multiple types of networks. Network interfaces 306 may comprise network interface cards, such as Ethernet cards, optical transceivers, radio frequency transceivers, or any other type of device that can send and receive information. Non-limiting examples of network interfaces 306 include radios compatible with several Wi-Fi standards, 3G, 4G, Long-Term Evolution (LTE), Bluetooth®, etc.

Power source 308 provides power to device 300. For example, device 300 may be battery powered through rechargeable or non-rechargeable batteries utilizing nickel-cadmium or other suitable material. Power source 308 may include a regulator for regulating power from the power grid in the case of a device plugged into a wall outlet, and in some devices, power source 308 may utilize energy scavenging of ubiquitous radio frequency (RF) signals to provide power to device 300.

Device 300 may also be equipped with one or more output devices 310. Output device 310 is configured to provide output to a user using tactile, audio, and/or video information. Examples of output device 310 may include a display (cathode ray tube (CRT) display, liquid crystal display (LCD) display, LCD/light emitting diode (LED) display, organic LED display, etc.), a sound card, a video graphics adapter card, speakers, magnetic, or any other type of device that may generate an output intelligible to a user.

Device 300 is equipped with one or more input devices 312. Input devices 312 are configured to receive input from a user or the environment where device 300 resides. In certain instances, input devices 312 include devices that provide interaction with the environment through tactile, audio, and/or video feedback. These may include a presence-sensitive screen or a touch-sensitive screen, a mouse, a keyboard, a video camera, microphone, a voice responsive system, or any other type of input device.

The hardware components described thus far for device 300 are functionally and communicatively coupled to achieve certain behaviors. In some embodiments, these behaviors are controlled by software running on an operating system of device 300.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of securely filling out one or more forms by a mobile device with a wireless network interface, the method comprising:
detecting a signal from a beacon using the wireless network interface;
determining a distance from the mobile device to the beacon using the detected signal from the beacon;
receiving the one or more forms from a remote server when the distance from the mobile device to the beacon is within a predetermined distance from the beacon;
populating fields in the one or more forms with the aid of a user information database, wherein the user information database stores centralized data used to fill the missing fields in the forms; and
sending the forms to the remote server.

2. The method of claim 1, wherein the one or more forms received from the remote server when the distance from the mobile device to the beacon is within the predetermined distance from the beacon is performed only after an affirmative response from the mobile device that the one or more forms from the remote server should be received by the mobile device.

3. The method of claim 1, wherein the distance from the mobile device to the beacon determined using the detected signal is determined based on a signal strength of the signal from the beacon as received at the mobile device.

4. The method of claim 1, further comprising requesting, by the mobile device, the one or more forms from the remote server when the distance from the mobile device to the beacon is within the predetermined distance from the beacon prior to receiving the one or more forms from the remote server.

5. The method of claim 4, wherein the requesting, by the mobile device, the one or more forms from the remote server is based on both the distance from the mobile device to the beacon being within the predetermined distance from the beacon and a digital calendar accessed by the mobile device indicating an appointment scheduled at the same time the distance from the mobile device to the beacon is within the predetermined distance.

6. The method of claim 1, wherein the user information database is stored in a memory of the mobile device.

7. A mobile device for securely filling out one or more forms, the mobile device comprising:
a wireless network interface; and
a processor configured for:
detecting a signal from a beacon using the wireless network interface;
determining a distance from the mobile device to the beacon using the detected signal from the beacon;
receiving the one or more forms from a remote server when the distance from the mobile device to the beacon is within a predetermined distance from the beacon;
populating fields in the one or more forms with the aid of a user information database, wherein the user information database stores centralized data used to fill the missing fields in the forms; and
sending the forms to the remote server.

8. The mobile device of claim 7, wherein the one or more forms received from the remote server when the distance from the mobile device to the beacon is within the predetermined distance from the beacon is performed only after an affirmative response from the mobile device that the one or more forms from the remote server should be received by the mobile device.

9. The mobile device of claim 7, wherein the distance from the mobile device to the beacon determined using the detected signal is determined based on a signal strength of the signal from the beacon as received at the mobile device.

10. The mobile device of claim 7, wherein the processor is further configured for requesting, by the mobile device, the one or more forms from the remote server when the distance from the mobile device to the beacon is within the predetermined distance from the beacon prior to receiving the one or more forms from the remote server.

11. The mobile device of claim 10, wherein the requesting, by the mobile device, the one or more forms from the remote server is based on both the distance from the mobile device to the beacon being within the predetermined distance from the beacon and a digital calendar accessed by the mobile device indicating an appointment scheduled at the same time the distance from the mobile device to the beacon is within the predetermined distance.

12. The mobile device of claim 7, wherein the user information database is stored in a memory of the mobile device.

13. A non-transitory computer readable storage device for securely filling out one or more forms by a mobile device with a wireless network interface, the non-transitory computer readable storage device having computer executable instructions for performing the steps of:
detecting a signal from a beacon using the wireless network interface;
determining a distance from the mobile device to the beacon using the detected signal from the beacon;
receiving the one or more forms from a remote server when the distance from the mobile device to the beacon is within a predetermined distance from the beacon;
populating fields in the one or more forms with the aid of a user information database, wherein the user information database stores centralized data used to fill the missing fields in the forms; and
sending the forms to the remote server.

14. The non-transitory computer readable storage device of claim 13, wherein the one or more forms received from the remote server when the distance from the mobile device to the beacon is within the predetermined distance from the beacon is performed only after an affirmative response from the mobile device that the one or more forms from the remote server should be received by the mobile device.

15. The non-transitory computer readable storage device of claim 13, wherein the distance from the mobile device to the beacon determined using the detected signal is determined based on a signal strength of the signal from the beacon as received at the mobile device.

16. The non-transitory computer readable storage device of claim 13, further having computer executable instructions for performing the step of requesting, by the mobile device, the one or more forms from the remote server when the distance from the mobile device to the beacon is within the predetermined distance from the beacon prior to receiving the one or more forms from the remote server.

17. The non-transitory computer readable storage device of claim 16, wherein the requesting, by the mobile device, the one or more forms from the remote server is based on both the distance from the mobile device to the beacon being within the predetermined distance from the beacon and a digital calendar accessed by the mobile device indicating an appointment scheduled at the same time the distance from the mobile device to the beacon is within the predetermined distance.

18. The non-transitory computer readable storage device of claim 13, wherein the user information database is stored in a memory of the mobile device.
